(19) United States
(12) Patent Application Publication
(10) Pub. No.: US 2001/0032257 A1
(43) Pub. Date: Oct. 18, 2001

(54) Method and system for managing information on a network

(76) Inventors: Ronald B. Wells, Herriman, UT (US); Daniel J. Ricks, Salt Lake City, UT (US)

Correspondence Address: Michael M. Conger, KIRTON & McCONKIE, Suite 1800, 60 East South Temple, Salt Lake City, UT, 84111, US

(21) Appl. No.: 09/822,917

(22) Filed: Mar. 30, 2001

Related U.S. Application Data
(60) Provisional application No. 60/196,311, filed on Apr. 12, 2000.

(51) Int. Cl. G06F 15/173; G06F 15/16

(52) U.S. Cl. 709/223; 709/204

(57) ABSTRACT

A networking system is disclosed that provides synchronization of information over the network using instantaneous, real time smart cache refreshing. The network utilizes a combination of a synchronous programming scripts, smart cached user requests and preferences, and semi-distributed processing, to optimize information flow, management, and updating over the network system.

### RELATED APPLICATION

The present patent application is related to Provisional Patent Application No. 60/196,311, filed Apr. 12, 2000, and claims priority to the application, which is incorporated by reference for all purposes.

### BACKGROUND

Background of the Invention

The present invention relates generally to the management of information across a networking system and, more particularly, the present invention relates to synchronizing information across a network using real time smart cache refreshing.

Database systems used to share information across networks are well-known to those skilled in the art. Typically, a main database store is used to hold information for use across the database and network. The system enables information to be selected by a user or a group of users, manipulated, and then re-saved to the database store so that only one authentic file or object is available for use by others or to be saved in the data store. This prevents other users from corrupting or modifying the original object that would lead to corruption or confusion and inaccuracy by allowing those others to access the object and modify it and then save it back to the data store without any control as to which saved version is the most correct or most accurate. For example, a text file may be accessed by a given author. Others that the author wishes to review the text file may access the text file at a point of last refresh by the author. Should the author, while accessing the text file, make further changes while the others are reviewing the file, the changes would not be apparent in the users' files nor would the users be able to make any changes that would otherwise corrupt the author's active version of the text file. In some systems, changes made by the author in real time will be transmitted from the author's version in a fan-like distribution to all open files to revise and update those active files.

Unfortunately, database management systems have struggled over the years to provide shared copies across the network system that do not become corrupt or corrupt the original file during use. Typically, the networking system allows only one active version of a file to be open where subsequent inquiries for the same file will receive merely a read-only file that prevents them from making changes that would be recorded back to the original file. Only the active author is able to make changes to the file, which changes are not transmitted to the users having merely read-only versions of the file. This approach prevents others from collaborating directly with the author in a real time fashion to modify the file in a useful manner to the author and those invited to comment thereon.

In other systems, an authorized version of the data or file can be accessed by multiple users and the system marks which files are active and when updates are made to that particular file, regardless of who is first in time in accessing the file. The updates are transmitted cross the entire network in an attempt to refresh the contents of any and all files opened over the network. This approach uses valuable resources in that all nodes of the network are targeted for transmission of the refresh document regardless of whether that node has the document open and active.

What is needed, however, is an information management system that enables multiple users access to the same information and minimizes system resources in providing data refresh of the active object across a networking system.

### SUMMARY OF THE INVENTION

A networking system is described that provides synchronization of information over the network using instantaneous, real time smart cache refreshing. The network utilizes a combination of a synchronous programming scripts, smart cached user requests and preferences, and semi-distributed processing, to optimize information flow, management, and updating over the network system. The system utilizes a method that receives requests for information, processes the information request, records who has requested the information, shares the information in a cache location, and provides information updates as received only to those participants recorded by the system. Upon notice sent by the client that the information is no longer needed, the system removes the client from the list so that no future updates are sent to that client. This limits the amount of data broadcasts over the network to only those that need the information, rather than to all members of the network, whether they requested the information or not.

The application is used in healthcare offices where often several practitioners or assistants need access to information to a given patient visiting the office. This allows the practitioners and assistants to view the information real time and with instant updates so that optimal care can be provided. Further still, inventory is managed more accurately and instantaneously as inventory requested are recorded instantly. Also, billing can be done simultaneously with the visit in an automated fashion.

The information can be cached either at the server where the information originates, or it can be stored at the server serving the client requesting the information. This modifies the lists so that either clients or servers are listed and then the information is sent to the members of the list, be they servers or clients. In all events, it is intended that the updates to the data store and from the data store be done asynchronous with other instructions executed over the network.

In an alternative information management process, information is sent to the main database and then additional information related to the new information is searched and retrieved to be sent to the client sending the new information. The new information is also incorporated into the database for other clients to access and retrieve. The information is shared with the requesting client. In one example, the information is patient diagnosis information and the information in the main database is correlated to the new information so a composite of information is made available to the client submitting the patient diagnosis. This shared information can be data about patients diagnosis with similar symptoms or conditions and offers treatments for such. In another approach, the system could be set up in a law office, an accounting or investment firm, or any other organization that has a need to manage data, correlate new data with old data, and share the correlated data with other participants.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a schematic diagram of a network system utilizing a smart caching system in accordance with the present invention.

FIG. 2 depicts a flow diagram of an information transport method for smart caching in accordance with the present invention.

FIG. 3 illustrates a flow diagram of an information maintenance and sharing protocol utilized within a client/server environment in accordance with the present invention.

### DETAILED DESCRIPTION OF SPECIFIC EMBODIMENTS

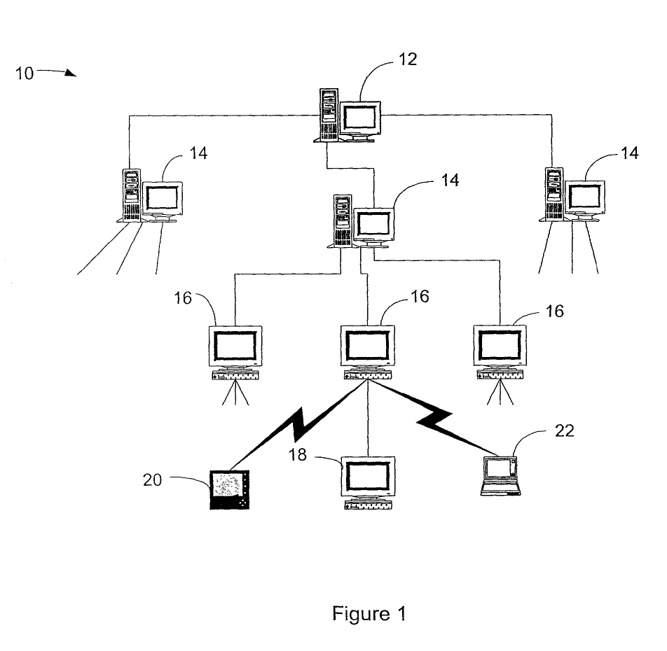

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1-3, is not intended to limit the scope of the invention, as claimed, but is merely representative of embodiments of the invention.

The specific embodiments of the invention will be best understood by reference to the drawings, wherein like parts are designated by like numerals throughout.

A networking system is described that provides synchronization of information over the network using instantaneous, real time smart cache refreshing. The network utilizes a combination of a synchronous programming scripts, smart cached user requests and preferences, and semi-distributed processing, to optimize information flow, management, and updating over the network system.

FIG. 1 illustrates a schematic diagram of a network system 10 that incorporates the information management system in accordance with the present invention. Network system 10, which can include various networks such as local area networks (LAN), wide area networks (WAN), intranet systems, and Internet applications, includes various servers and clients well-known to those skilled in the art. Network system 10 includes a central database store 12 as the main repository of all information to be stored in the database. Database store 12 can be based on traditional database management systems that are commercially available such as, for example, SQL Server 7.0 or SQL 2000, both offered by Microsoft, or ORACLE9i DATABASE, offered by Oracle. Other database management systems comparable to the SQL system may be freely substituted. Further, there may be more than one database store 12 within the network system 10 either as back-up or as a main store for alternative information and to increase access efficiency.

Data store 12 is further coupled to a plurality of central servers 14 and are utilized to maintain smart caches of the active information obtained from data store 12. Each central server 14 is generally compatible with the database management system language, such as ODBC or OLE. Each central server 14 is further coupled to a plurality of local or client servers 16. Communication between central server 14 and client server 16 can be provided via various networking protocols, one such protocol involves TCP/IP. Each local server 16 can also maintain a smart cache of the information requested from data store 12.

Each local server 16 is then coupled to a plurality of computer systems such as work station 18, personal digital/data apparatus 20, or lap top 22. Connection between local server 16 and the various computer systems can be either through a conventional network system using a communications protocol such as TCP/IP or IPX/SPX, over the Internet, or via wireless transmission as illustrated with respect to PDA 20 and laptop computer 22. Although various levels are illustrated with respect to the network system 10 of FIG. 1, it should be understood that the relationship between server and client exists only at a first and second level without actually requiring there be more than the two levels. What is significant is that one system serves as the smart cache controller within the network to manage information accessed by one or more users and then to provide smart cache updates and refreshes over the network system 10 in accordance with the present invention.

When a client or clients requests information, each request is sent through its local server and then forwarded to the server that manages the database from where the information is to be extracted. This information, typically instantiated as an object, is then cached within a memory location within the server and sent to the client through the network connection. When a similar request is made by another connection or client, only one copy is stored in memory as a cache version and a counter is then associated with that particular information segment and incremented to indicate the number of requests made for that information. Further, a list is established of each client that has made a request for that information and has received a copy thereof. As the client removes itself from the list by closing the information or indicating that it no longer needs the information, the list removes the name of the client, i.e., its identification location, and decrements the counter to indicate that one fewer objects of the information is active. Once all clients are finished with the information, the information is de-cached and removed from memory and restored back to the data store. This implementation enables the network system 10 to know which clients are interested in what information at all times. Thus, if a refresh is performed on the cached information, the list is examined to determine which parties are interested in any updates and the updated information is then broadcast only to those clients on the list, thereby eliminating broadcasting the information throughout the network as done in the prior art.

Additionally, the information need not be cached only at the server from which the information or data is requested, but can also be cached at the local server from which the client made the original data request. Thus where there are multiple client/server transactions to be completed for accessing the information and performing updates, caching the information locally, even though the information did not originate locally, speeds up a client's access to the information over that of caching the information at the server local to the database only. Further still, the information can be cached at each server level where a client has made a request for the information, thus allowing each client local cached access to the data. When the information is updated, the update is sent only to those servers caching the information, which keeps a list of local clients requesting the information in the first place.

Accordingly, the server local to the database can keep a list of only those servers caching the information locally for the requesting client(s) or the server can keep a list of all clients requesting the information and send updates to those parties on the list, be it servers or clients. With the servers having local cache copies of the information, this manages resources better as any update need only be forwarded to the servers on the list, rather than to each client individually. Then, the server sends the updated information to the clients on the local server's list. A server/client listing can be made or dedicated server lists or client lists can be done at the central server controlling the point of origin for the information, or both the client list at each local server and the server list at the database server can be used where appropriate to optimize caching and notification and information update distribution.

Clients are notified when information that they have requested and are still interested in has changed. The changes are then sent from the client making the change to the servers. The servers then write the requested changes to the database. The updated information is then sent to all clients who have expressed interest in that specific information, i.e., that are on the list of interest. When changes do occur, information is not refreshed by a client request or by a blanket broadcast message from the server, rather, by the server based upon registered interests of the client initiates selective updates. These selective updates can be timed updates, sequence driven updates, pre-selected updates schedules, and the like. This prevents confusion and arbitrary updating within the network system in that whenever a client makes a change, an update need not be generated at all times. Different update protocols can be followed. The most common protocol is by time of update. Thus, if one user updates the information prior to another user, the first update will be broadcast to all participating clients before the second update is allowed. If the second update is made nearly instantaneously with the first update, it will actually over write the first update at the database server level and notify the first party to update that a conflict exists and that the first party should review the new update before submitting the first party's update. This prevents corruption of data during competing updates. It is very rare that such a conflict will occur, but the solution is just to have the first party resubmit the update for the database.

Other protocols can be set up to avoid the conflict of nearly instantaneously updates. Specifically, the protocol can honor the first in time up date over any other near instantaneous updates and require the second party to review the information to be submitted in view of the update information the first party submitted. This controls conflicts in updates. Other protocols are also possible that can be a hybrid of either or both. What is important is that no real conflict occurs or are handled judiciously so that no data is corrupted or lost.

Next, when updated information is received by a client, it is parsed by a centralized view registration object. As many views may be interested in a single piece of information, the synchronization object determines which views are active and interested in the information and then passes the information on to those views or clients. The clients themselves are responsible to review the new information when it is received.

Each information request and response operates in an asynchronous manner. The use of asynchronous transport protocol enables the processor to perform other operations while the requests are pending. This allows the processor to be active in all aspects without being captive by a busy wait typically found in synchronous transport protocols.

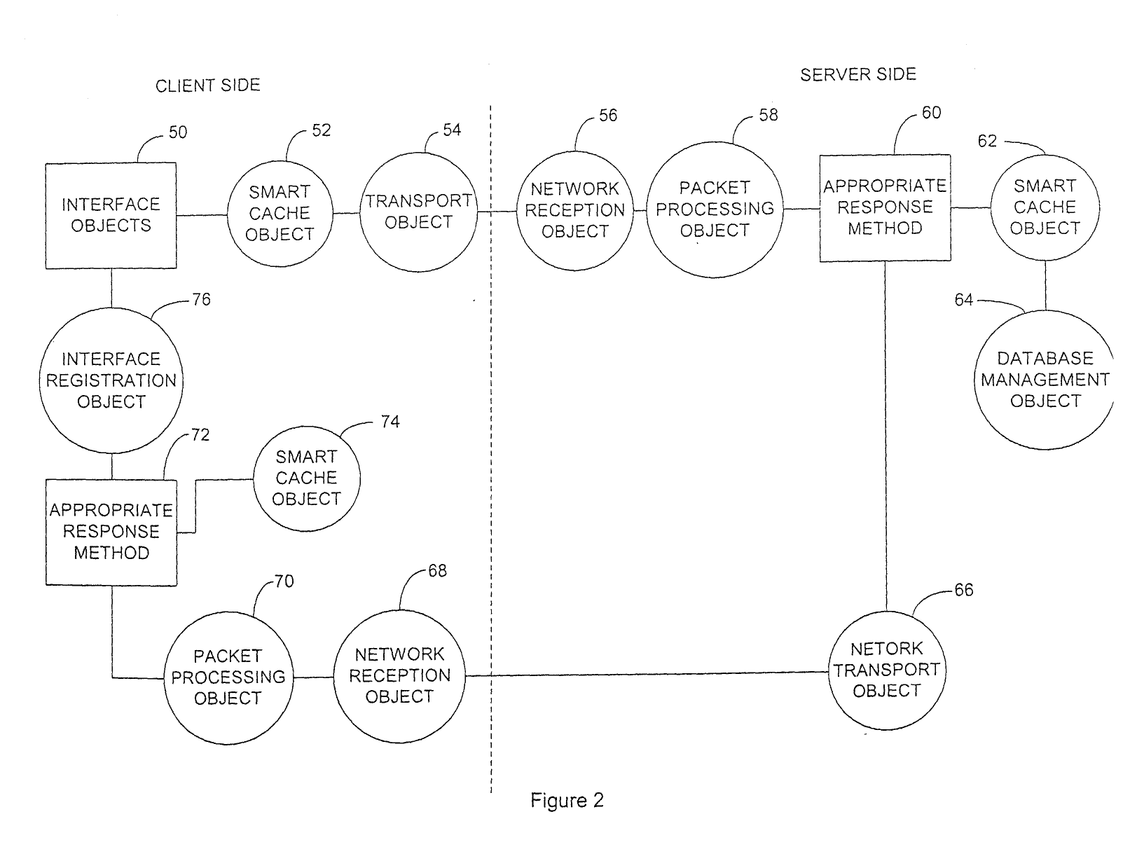

The information management protocol used by the network system 10 of FIG. 1 is shown in greater detail in FIG. 2. FIG. 2 illustrates a network transport process or protocol regarding the sharing of information, caching of that same information, updating the information, and notifying active clients interested in the updated information of such updates. The transport process involves the use of objects and follows standard object oriented programming, which is well-known to those skilled in the art. The process typically begins on the client side where the client makes a request for a selected information item. This request is found in the interface objects 50, which then instantiates a smart cache object 52 of the request. From here a transport object 54, which is then encrypted and compressed for transmission through the network system, is generated and then passed to the server side where it is received as network reception object 56. At this point, the transport object 56 is decompressed and then decrypted for reading and interpretation. Next, the request is processed as a packet object in processing object 58 and translated. Next, the server side performs an appropriate response method within block 60.

Once the process is properly translated and processed, the response is obtained from the database store of FIG. 1 and is instantiated as a database management object 62, which is also stored as a smart cache object 64. The database management object is then forwarded to the client side via a network transport object 66. The network transport object 66 compresses and encrypts the information in object form before transfer from the server to the client. The client receives the network transport object 66 as a network reception object 68, where the client decompresses and decrypts the information and object. The client then processes the decrypted and decompressed information via packet processing object 70 before sending the information to the appropriate response method block 72. At this point, the information is then placed in a smart cache object 74 and then subsequently registered as an interface registration object 76. It is at interface registration object 76 that views of the information are then forwarded to the client making the information request. These views go not only to the originally requesting client but also any subsequently requesting client when there are a plurality of clients requesting the same information view.

Interface registration object 76 maintains a list of all clients interested in the particular view. This list is important as it determines who is to receive updates of information when that information is refreshed by the server. Subsequently, when a client removes the information from their system, notice is sent to the interface registration object list to delist that client indicating that the client is no longer to receive refresh updates. Thus, only those clients on the list will receive a refresh update of the information when it is sent from the server. This eliminates the need to send the refresh update throughout the network system and targets only those actually interested, thus reducing resource needs and increasing efficiencies.

Using the same pattern, updated information is sent from the client side to the server side for update and refresh on the server's cached object. The updated information is sent as a transport object where it is encrypted and compressed prior to being received as a network reception object where it is then decompressed and decrypted on the server side. next, the packet is then translated as a packet processing object and then processed using the appropriate response method before being stored with the database management object as well as the smart cache object. Once the server is satisfied that the update is complete and accurate, a broadcast is performed to all clients on the interested list on the interface registration object list. The information is then instantiated as network transport object prior to transmission to the client side and received as network reception object. The network transport object compresses and encrypts the transported information where it is decrypted and decompressed on the client side. The decrypted and decompressed information is then passed as a packet processing object to the appropriate response method where it is then saved as the new smart cache object then forwarded as the new view to all the clients on the interface registration object list.

The operation and process of the network transport protocol has been described. The usefulness of this advanced protocol will now be made apparent. The network protocol may be utilized in various operations and situations where information is held to a premium and must be shared across many clients. This includes such professions as the medical profession, the legal profession, the accounting profession, and other business practices where shared information is the rule rather than the exception. The ability to control the updating of information and minimize its transport throughout the network to only those actually interested in the information helps the network system reduce information transport traffic and requests as well as limit the amount of caching needed to be performed at the various servers where no such information actually is requested.

One professional area where the advantages are clearly seen as that of the medical profession. Specifically, the information transport protocol enables a medical practice to achieve an interactive medical record information system that is very responsive to information requests, strictly maintains accuracy of the information, and optimizes resources within the network and the medical facility. The networking protocol is able to provide nearly instantaneous interactive medical information via user-individualized wireless electronic charts. These typically are utilized by health care professionals such as doctors, nurses, therapists, and the like. Each wireless electronic chart, typically illustrated as PDA 22 of FIG. 1, can be customized for each doctor/patient interaction at the point of care. The system provides a suite of tools available to the healthcare provider. Typically, the system is based in a practice group that may be associated with a larger healthcare provider organization such as a healthcare maintenance organization or a hospital entity. Typically, patient information is stored in a database store, such as that of database store 10 of FIG. 1, and then communicated to central and local servers and client upon request through the network system 10.

The medical care facility may be a group of doctors working in a single office or a sole practitioner working in a suite of offices having supplementary care givers such as nurses and technicians. In either situation, multiple healthcare provider personnel need access to the patient information at the same time. For example, a patient may come in for routine testing, and while the doctor is performing an exam of the patient, a technician may be running diagnostic tests of blood and urine samples simultaneously. This requires both healthcare providers have access to the patient's information simultaneously and any updates must be communicated one with another without conflicts that would otherwise jeopardize the patient or conflict in a diagnosis made by the primary health care provider or doctor. Further, inventory control can be accomplished instantly by noting when supplies are ordered for a particular patient and accounting for such requests so that inventory can be replenished in a timely manner. Further still, the billing or accounting department may be notified of the patient's visit so that billing statements can be made ready at the conclusion of the patient's visit. This allows accounting to provide accurate and prompt billing information for the patient's insurer, should there be one. Thus, it is shown that more than two parties may need access to a patient's history during a single visit and updates to each participating party is desirable.

As there are multiple users accessing the same information, it is necessary to provide a networking system that is able to perform distributive processing along with the smart client server foundation to allow continuous communication with the central database. Because the networking system continues to control the information to prevent corruption as much as possible by, in part, limiting who has access to it, distributive processing and continuous communication become necessary. The client server network is able to track all users who are accessing the same information or data, such as a patient's schedule, information, history, etc., and serves out and synchronizes this information in real time during a patient's office visit or treatment session. Since only those that have a need to use this information are notified and allowed access to this information, the system inherently minimizes bandwidth use at all times.

In a medical practices group, the software suite can provide additional functionality such as office administration, work flow assistance, billing and payroll management. Further still, the networking system enables information such as a patient's charts and medical records to be electronically generated in a conservative and efficient manner without imposing added burdens on the network band width. For example, when a patient comes into a health care provider's office, such as a visit to the doctor or dentist, the patient checks in to open a file for that day. At that time, a file is opened for the primary physician or dentist and a second file is opened for accounting, so that billing and payment can be transacted after treatment and before the patient leaves the office. This payment can be directly by the patient or partial by the patient and the insurer or directly by the insurer.

Through this information, doctors can develop greater care management of the patient as well as utilize a diagnostics tool found within the suite. Further, health coding compliance assistance is also provided that enables more accurate record keeping for billing purposes and insurance disbursement such as through private insurance and public health insurance providers such as Medicare and Medicaid. Appointment and facilities scheduling software can be maintained so that all personnel accessing the medical facilities will know of specific appointments and facilities for scheduling instantaneously rather than having to search for usually a point person who coordinates such scheduling.

As the network protocol is operable over internet systems, other advantages and benefits are possible. For example, a warehouse can be maintained where information from all registered medical practice groups that are not normally affiliated one with another can participate in a comparative/collaborative information website. This site would augment the network system's instant data collection capabilities for patients within a particular medical facility. The information can be automatically compiled on the internet site to prepare summary statistics for all aspects of the practice and perform continuous real time uploads of these statistics to the warehouse website. It is significant to note that the information can be provided in a confidential and discreet manner where no patient identifiable information is provided and is only performed where the physician's prior approval has been obtained. This data is then utilized for benchmarking purposes to provide a worldwide benchmarking database available to those participants of the Internet warehouse system. It is caching the information at a server local to the client that is also urged as this provides faster access to the information by the client other than trying to obtain it repeatedly over the internet.

The comparative data generated by this collection of information across many healthcare provider facilities is then transmitted back to the healthcare providers in comprehensible, graphical form, which allows them to compare their practice results against the practices of providers in the same or other regions. This provides the tracking and benchmarking of physicians' clinics and disease management in a continuous manner. This process gives clinics an expanded experience base on which to draw, equivalent to a large multi-practice clinic composed of benchmarked clinicians throughout the region.

This Internet warehouse site of medical information also offers patients the convenience to preregister, check scheduling, and lab results, obtain electronic referrals, and e-mail their physicians.

The growing database that provides instant information is also useful for researchers who need access to information available on diseases, drug utilization, efficiencies, and outcomes, among others. This is done anonymously to protect the patient's privacy.

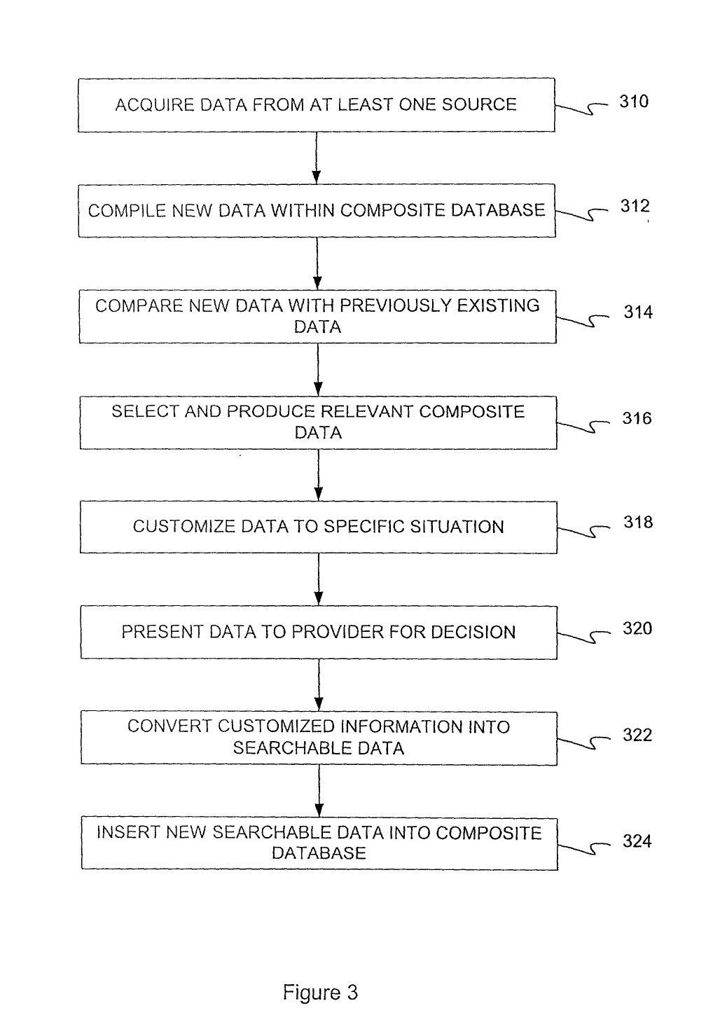

The database is built up through the addition, revision, and comparison of new data information with current data stored previously in the database. The process for customizing the data information for use by practitioners is illustrated in the flow diagram of FIG. 3. Initially, the system acquires data from various sources as shown in block 310. The data include patient information, provider information, payer information, billing information, outcomes information, testing and exams performed for the patient, etc. These elements of information are acquired from various sources, such as directly from the patient, from the patient's insurance coverage, from the health care provider, and from any other medical health care providers servicing the patient and participating in the collection of such vital information.

Next, in block 312, the various data sources are automatically positioned in new composite databases within the standard database of FIG. 2. The process of adding the new data sources includes sorting and correlating them within the database. Data correlation includes comparing the new data with data currently stored within the database to determine the relevance of the new data relative to the stored data. Thus, when a patient diagnosed with cancer is treated by the healthcare provider, the information of the treatment is sent from the healthcare provider to the database store and correlated with other relevant and stored cancer information regarding treatment, recovery, prognosis, and the like. The new data is presented for comparison to the existing data, in part, to determine proper diagnosis or treatment based on data stored within the data stores that are based on similar situations for similar patients to help provide a diagnosis or plan of treatment for the patient. Thus, in block 314, the system handles the data for comparison relevant to the existing data.

When a healthcare provider is seeking information through the database, which includes processing patient data within an appropriate server of FIG. 1 and comparing it to data stored in the data store, as shown in block 316, relevant composite data is then retrieved and forwarded to the requesting healthcare provider. The data is customized to the specific situation described by the healthcare provider, as shown in block 318, and then presented to the provider so that the provider can make the appropriate decision affecting the patient as shown in block 320. For example, the cancer patient previously mentioned would be prescribed with a treatment regimen based on decisions made for similar patients in similar situations. This treatment schedule could include chemotherapy, surgery, lifestyle changes, or other treatments that would be beneficial and helpful to the patient.

In another example, the information can also focus exclusively on the healthcare provider's own history of treating patients, or on a combination of the healthcare provider's history and that found within the database. Further still, the patient's own health history and the family history of the patient would also be considered. Thus if the physician sees a patient with a sore throat, a list of standard procedures and questions would be set up for the doctor as the patient is asked about the symptoms. This would be a dynamically generated patient-doctor specific checklist of these possible choices offered by the doctor for the patient. As the doctor selects symptoms, possible diagnosis consistent with previous diagnosis made by the doctor would be displayed to the doctor. The doctor could also take into consideration the patient's health history or family history in making a diagnosis. So, when the patient with the sore throat visits, the doctor could readily see that strep throat is commonly diagnosed and consider that as what ails the patient or the doctor could see that the patient's health history would suggest something other than strep in that situation.

Next, the new information is converted into searchable data, as shown in block 322, that is subsequently used within the data store for the next correlation opportunity a different patient having similar symptoms submits or requests information to or from the data store for a consensus decision based on previous decisions made for patients under similar circumstances with similar symptoms and stored upon the data store. Since new data aid in expanding and refining information based on another patient's sampling, the system, as shown in block 324, adds the new information as new data within the composite database. Further, this updating of information can rely upon the caching system previously described such that clients who are on a list of the cached information can be informed of updates to the database. This is helpful for example for a research group that is focused on a particular problem and wants all new information added related to the problem being researched by the group. Thus, when a cancer research group participates with the sharing of data, new data can be automatically forwarded to the research group after it is added to the database. The research group is in the cache system. Alternatively, a request for updates may be sent by the group to the server managing the data store where the request is for all updates since the last request. This can be done by someone in the group or automatically through a timed or standing request.

The maintenance of data as outlined above within the data store for the client/server network of FIG. 1 allows information to be transmitted between users and the database instantaneously and to cache information needed by the healthcare provider. Thus, as the healthcare provider uploads information relevant to the particular patient for comparison and retrieval of relevant information with the composite data store, a prompt reply may be given to the healthcare provider that is customized and presented to the healthcare provider who has exclusive rights to that information. If additional individuals are working with the patient simultaneously, then they would receive information consistent with their request and would have access to all new information submitted by any other individual. Further, the addition of new data from different sources improves the database as it grows broader and more robust, thereby being able to provide more specific information for subsequent patients and inquiries. Additionally, the system performs automatic data filing, quantifying, and comparison to provide optimal search and data results when subsequent users provide new data for submission and for searching of correlating data utilized for analysis and support.

For the patients, this results in a more reliable and improved diagnoses offered by the healthcare provider as the healthcare provider is able to tap into the collective abilities of all participating healthcare providers in the data store. This also improves the treatment regimens since the most up-to-date regimens can be suggested and offered due to the instantaneous access to new information and coordination of such information through the data store system. The patient is also able to enjoy improved or more accurate prognoses. Improved etiologic determinations can also be made as well as improved outcomes for the patient. Patients further enjoy reduced costs due to shorter visits, more accurate diagnosis, and more beneficial treatment based on the cumulative knowledge of all participants.

The provider benefits as well in that charting times become shorter. Further benefits include instant access to all relevant information is provided and more accurate diagnoses of the patients. Further still, health care providers achieve decreased liability exposure as the healthcare provider has access to a much broader database of relevant information pertaining to a patient's similar circumstances. Lastly, the method also provides a more accurate coding and billing system than was otherwise provided. This is achieved by the instantaneous ability of the network to process the billing codes and send notice to the insurance companies or Medicare/Medicaid for billing processing consistent with the billing codes required and used. This also benefits the healthcare facility or office in that the office obtains lower costs, lower data entry and collection times, more accurate billing, prompt payment from the insurance company or government agency, and increased revenues.

The data base store and retrieval also provides a mass customization of the data for the participating healthcare providers even though there are unique patient patterns involved at each situation. Although the unique patient patterns typically prevent a mass produced result, there is much commonality of symptoms and diagnoses even among the patients so that common patterns enable the system to provide customization in a mass produced manner. This is achieved by generating what is actually known as a close match pattern based on the patient information as matched to composite data previously stored relating to patients having similar circumstances, symptoms, or experiences. This results in customized diagnoses and prognoses for each patient that is actually unique for that particular patient in an automated fashion. For example, the doctor who sees a series of patients with sore throats as previously mentioned has the dynamic check list that suggests treatment regimens of rest, proper nutrition, antibiotic treatment, etc. as a beginning point in the exam.

This process is not limited to the medical arts, but is transportable to other fields, such as accounting, law, inventory, data management, and the like. For example, in accounting, different scenarios of investment options can be assimilated within a common database where new information pertaining to a new client is compared to relevant information to determine an appropriate investment vehicle based upon the client's stated goals, backgrounds, financial abilities, and objectives. This allows for mass customization to be achieved in recommending investment strategies at different levels. Further, the process can be applied in the law field in that similar fact patterns can be quickly resolved with other fact patterns from a new client and retrieve appropriate opinions customized to the new client's situation. As the database of situations grows, the ability to provide a solution suitable to the client becomes more likely. Further, in the example for law practices, the outcomes of judicial cases can also be stored within the data stores for enhancing the opinion to be provided to the particular client. This can be done either by reporting the outcome of the decision as submitted previously by a given law firm or attorney or by incorporating law journals and other digests as they become available.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A network system for managing information comprising:
a database store, in which information is stored and requested across the network system;
a plurality of clients, communicatively coupled to the database store, wherein at least one of the plurality of clients makes request of information from the database store; and
information access control to control the sharing of information requested by the at least one client by maintaining a list of those clients requesting the information and forwarding updates of the information to those clients on the list only.

2. The network system according to claim 1 wherein the information access control includes a smart cache controller to manage information accessed by one or more clients.

3. The network system according to claim 2 wherein the smart cache controller stores information within cache memory and provides caching updates to the client as the cashed information is updated.

4. The network system according to claim 1 wherein the information access control caches information requested for as long as the information is required and removes the information from cache when no longer needed by the client.

5. The network system according to claim 1 wherein the client indicates to the information access control to remove the client from the list, thereby ending information updates to that client.

6. The network system according to claim 1 wherein the client is identified by location.

7. The network system according to claim 1 wherein the information access controller writes the changed information on the database store.

8. A method of managing information across a client/server system comprising:
storing information on a database store managed by a server;
requesting information on the client/server system by at least one client;
granting the requested information to the requesting client;
preparing a list of clients requesting the information;
providing updates of the requested information only to those clients listed.

9. The method according to claim 8 further comprising the step of removing a client on the list based on the client's indication that the information is no longer needed.

10. The method according to claim 8 further comprising the step of updating the information on the database store.

11. The method according to claim 8 further comprising the step of storing the information client list on the server managing the requested information.

12. The method according to claim 8 wherein the information requesting step and the information updating step are asynchronous with one another.

13. The method according to claim 8 wherein the updates are performed on a timed schedule, in a sequential manner, or according to a pre-selected schedule.

14. A method of managing information across a client/server system comprising:
storing information as data on a database store controlled in part by the server;
at a client side, generating a request for specific data stored on the database store;
caching the requested data as a smart cache object on the server side;
forwarding to the requesting client a view of the smart cache object;
providing an interface registration object to maintain a list of clients receiving a view of the smart cache object.

15. The method according to claim 14 further comprising the step of asynchronously updating the smart cache object and the view thereof.

16. The method according to claim 15 further comprising the step of forwarding the updated view to each client maintained on the list.

17. The method according to claim 14 further comprising the step of sending a request from a client to the server to remove the client from the list.

18. The method according to claim 14 wherein the interface registration object utilizes a client location to identify a client on the list.

19. The method according to claim 14 further comprising the step of sending update information of the data to the server maintaining the smart cache object.

20. The method according to claim 14 wherein the client/server is maintained within a medical office facility.

21. A method of automatically organizing data and sharing data in response to a data request, comprising:
maintaining a database store of data;
submitting new data to the database store;
correlating the new data with data stored within the database store;
selecting data stored within the database store based on the correlation of the new data with the stored data;
storing the new data within the database store based on its correlation;
sharing the selected correlated data with the source submitting the new data.

22. The method according to claim 21 including the step of caching the selected correlated data.

23. The method according to claim 21 including the step of generating a list of each client receiving the selected correlated data.

24. The method according to claim 23 updating the selected correlated data that has changed to each client on the list.

25. The method according to claim 24 wherein the data updating is done asynchronously on the client/server.

26. The method according to claim 21 wherein the data is related to healthcare provider information for medical and health care offices.
